(19) United States
(12) Patent Application Publication
(10) Pub. No.: US 2009/0269521 A1
(43) Pub. Date: Oct. 29, 2009

(54) POROUS STRUCTURED THERMAL TRANSFER ARTICLE

(75) Inventor: Phillip E. Tuma, Faribault, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/109,128

(22) Filed: Apr. 24, 2008

(51) Int. Cl. B41M 5/40; B05D 3/02

(52) U.S. Cl. 428/32.74; 427/383.1

(57) ABSTRACT

Provided is a porous structured thermal transfer article comprising a plurality of precursor metal bodies and a plurality of interstitial elements disposed between and connecting the plurality of precursor metal bodies to one another and a plurality of metallic particles at least partially embedded in the interstitial elements. The precursor metal bodies comprise an inner portion comprising a first metal and an outer portion comprising an alloy comprising the first metal and a second metal. The interstitial elements comprise the alloy of the outer portion.

### FIELD

The present invention relates generally to a porous structured thermal transfer article. More particularly, the present invention relates to a shaped porous metallic article and methods of making and using the same.

### BACKGROUND

One cooling system for heat-dissipating components comprises fluids that evaporate or boil. The vapor produced is then condensed using external means and returned back to the boiler. To improve heat transfer of the fluid at the boiler, a porous structured thermal transfer article can be used.

A variety of porous thermal transfer articles are available, including, for example, coatings made by flame or plasma spraying. These coatings are generally metallic and are applied to metallic substrates by various processes. With these processes, it can be difficult to control porosity and evenly coat three-dimensional substrates. Other known coatings comprise conductive particles joined with organic binders. These coatings generally have poor bulk thermal conductivity and therefore require precise thickness control that is difficult on substrates with three-dimensional surfaces.

Passive two phase or boiling thermosyphons have been designed for use cooling heat-sensitive components such as microprocessors. Thermosyphons are passive heat transfer devices that circulate liquid based upon natural convection. They can avoid the cost and complexity of a liquid pump in a conventional heat exchanger.

### SUMMARY

As integrated circuits and other heat dissipating electronic devices become more powerful and compact, the rate of heat transfer away from these heat-dissipating components needs to be increased. Thermosyphons can provide cost-effective ways of cooling those components. Accordingly, there is a continuing need to develop porous structured thermal transfer articles with high heat transfer coefficients that can make thermosyphons and other heat exchangers inexpensive and more efficient. Further, there is a continuing need for inexpensive porous thermal transfer articles that can be easily applied in a manufacturing process.

Provided are porous structured thermal transfer articles. More particularly, provided are porous metallic articles and methods of making and using the same. The articles can be used as evaporators for cooling devices such as refrigeration systems and electronic cooling systems. The porous structured thermal transfer articles can be used in both single or two-phase heat transfer systems. In some embodiments, the articles can be used as a boiler plate in a thermosyphon used to cool an integrated circuit such as, for example, a microprocessor. In other embodiments, the articles can be attached to devices such as insulated gate bipolar transistors (IGBTs) that are immersion cooled.

In one aspect, provided is a porous structured thermal transfer article that includes a plurality of precursor metal bodies comprising an inner portion that includes a first metal selected from aluminum, copper, silver, and alloys thereof, and an outer portion that includes an alloy, wherein the alloy includes the first metal and a second metal selected from copper, silver, silicon, and magnesium, and wherein the first metal and the second metal are different; a plurality of interstitial elements disposed between and connecting at least two of the plurality of precursor metal bodies to one another, the interstitial elements comprising the alloy of the outer portion; and a plurality of metallic particles at least partially embedded in the alloy of the outer portion.

In another aspect, provided is a method of forming a structured thermal transfer article that includes providing a thermal transfer coating that includes a binder and a plurality of precursor metal bodies, the precursor metal bodies comprising an inner portion comprising a first metal having a melting temperature Tₘₚ₁, and an outer portion comprising a second metal having a melting temperature Tₘₚ₂, applying a plurality of metallic particles to the coating, and heating the composition to a temperature less than Tₘₚ₁ and Tₘₚ₂ to form an alloy comprising the first metal and the second metal that bonds the plurality of precursor metal bodies to one another, wherein the bond forms a porous matrix, and wherein the plurality of metallic particles is at least partially embedded in at least a portion of the matrix.

All scientific and technical terms used herein have meanings commonly used in the art unless otherwise specified. The definitions provided herein are to facilitate understanding of certain terms used frequently herein and are not meant to limit the scope of the present disclosure.

As used herein:

the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise;

“aspect ratio” refers to the ratio of the longest dimension of a three-dimensional body (i.e., “overall length”) and the longest dimension orthogonal to the overall length dimension (i.e., “overall width”);

“effective porosity” refers to the interconnected pore volume or void space in a body that contributes to fluid flow or permeability in a matrix. Effective porosity excludes isolated pores that may exist in the matrix. The effective porosity of a structured thermal transfer article of the present disclosure is measured exclusive of non-porous substrates or other non-porous layers that may form part of the structured thermal transfer article;

“precisely shaped thermal transfer composite” refers to a thermal transfer composite having a molded shape that is approximately the inverse of the mold cavity that is used to form the molded shape; and

“structured thermal transfer article” refers to a thermal transfer article comprising a plurality of three-dimensionally shaped thermal transfer composites;

“substantially spherical” refers to three-dimensional body having an aspect ratio between about 1 and 1.5 and a generally spherical shape;

“substantially vertical” refers to an orientation that is close to 90 degrees from a horizontal plane; and

“unit density” refers to the quantity of designated units per a specified volume. For example, if a porous matrix as described in the present disclosure comprises 100 precursor metal bodies and occupied a volume of 1 cubic centimeter, the unit density of the precursor metal bodies would be 100 precursor metal bodies per cubic centimeter.

The above summary is not intended to describe each disclosed embodiment of every implementation of the present invention. The brief description of the drawing and the detailed description which follows more particularly exemplify illustrative embodiments.

### BRIEF DESCRIPTION OF THE DRAWINGS

FIGS. 1a and 1b are perspective views of two coated substrates that can be used to make embodiments of the provided thermal transfer articles.

FIG. 2a is a side view of two exemplary precursor metal bodies used to make provided structured thermal transfer articles.

FIG. 2b is a cross-sectional view of the two exemplary precursor metal bodies shown in FIG. 2a.

FIG. 2c is a side view of the two exemplary precursor metal bodies shown in FIG. 2a after an interstitial element is formed to attach the two bodies together using a provided method.

FIG. 3 is an exemplary perspective view of a portion of an embodiment of a provided porous structured thermal transfer article.

FIG. 4 is an exemplary cross-sectional side view of a portion of an embodiment of an exemplary structured thermal transfer article.

FIG. 5 is a cross-sectional view of an exemplary precursor composite body comprising a coated diamond.

FIGS. 6a and 6b are photographic depictions of an embodiment of a provided porous structured thermal transfer article at different magnifications.

FIG. 7 is a schematic view of an exemplary apparatus for making substrates that are useful for making embodiments of provided articles.

FIG. 8 is a graph showing the experimental results of the thermal resistance of an exemplary embodiment.

These figures, which are idealized, are not to scale and are intended to be merely illustrative of the present the structured thermal transfer article of the present disclosure and are non-limiting.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Structured thermal transfer articles that can be used as evaporators for cooling devices such as refrigeration systems and electronic cooling systems have been described. The thermal transfer articles can be used in both single or two phase heat transfer systems. In some embodiments, they can be used as a boiling plate in a thermosyphon used to cool an integrated circuit such as, for example, a microprocessor. In other embodiments, they are attached to a heat generating device such as an insulated gate bipolar transistor (IGBT) that is cooled by two phase immersion. Structured thermal transfer articles generally are less efficient for two phase heat transfer when oriented in a more or less vertical orientation (substantially vertical) than when used in a substantially horizontal orientation. It has been increasingly common for circuit boards on desktop computers that contain heat-producing components to be installed in a non-horizontal orientation (i.e., substantially vertical) and for cooling devices, such as thermosyphons to be attached to the components in that orientation. Additionally, in order to increase the efficiency of cooling it is common to increase the surface area of a boiling plate or structured thermal transfer article by adding fins or projections to the surface of the plate. This can add expense to the cost of manufacturing such plates or articles. There is a need for structured thermal transfer articles that are efficient at transferring heat regardless of orientation and that can be manufactured at low cost.

In one aspect, provided is a porous structured thermal transfer article that includes a plurality of precursor metal bodies comprising an inner portion comprising a first metal selected from aluminum, copper, silver, and alloys thereof, and an outer portion comprising an alloy that includes the first metal and a second metal selected from copper, silver, silicon, and magnesium, wherein the first metal and the second metal are different; a plurality of interstitial elements disposed between and connecting at least two of the plurality of precursor metal bodies to one another, the interstitial elements comprising the alloy of the outer portion; and a plurality of metallic particles at least partially embedded in the alloy of the outer portion. By embedded it is meant that there is a physical bond between at least a part of the alloy and the metallic particles. This bond can be a weld, braze, solder, or any other type of metallurgical bond known to those of skill in the art. This bond holds the metallic particles in place and also makes them a joined part of the provided articles. Precursor metal bodies that can be useful typically have an average diameter of at least 1 micrometer (μm). In some embodiments, the precursor metal bodies have an average diameter of at least 5 μm. In yet other embodiments, the precursor metal bodies can have an average diameter of at least 10 μm. The precursor metal bodies that are useful for making the provided articles can have an average diameter no greater than 100 μm. In some embodiments, the precursor metal bodies have an average diameter no greater than 50 μm. In yet other embodiments, the precursor metal bodies have an average diameter no greater than 30 μm. The provided precursor metal bodies can have an aspect ratio in the range of 1 to 2. In other embodiments, the precursor metal bodies can be oval shaped and can have an aspect ratio greater than 1.5. In yet further embodiments, the precursor metal bodies can be polyhedrons (e.g., cubo-octohedral) or other randomly shaped bodies, including, for example, flake, chip, particle, plate, cylinder, and needle-shaped bodies. If the precursor metal bodies are non-spherical, the “diameter” of the body refers to the dimension of the smallest axis in each body, and the “average diameter” refers to the average of the individual body diameters (i.e., dimension of smallest axis in each body) in the population.

The precursor metal bodies can include an inner portion that comprises a first metal selected from aluminum, copper, silver, and alloys thereof, and an outer portion comprising an alloy that includes the first metal and a second metal selected from copper, silver, silicon, and magnesium. The first metal and the second metal are different. In some embodiments, the outer portion is uniformly applied to the inner portion such that the outer portion has a uniform thickness. In other embodiments, the thickness of the outer coating can vary. In some preferred embodiments, the outer portion covers a majority of the outer surface of the inner portion. In some embodiments, the outer portion covers more than 90 percent of the outer surface of the inner portion. In yet further embodiments, the outer portion covers the outer surface of the inner portion completely. The provided porous structured thermal transfer articles can be formed from large numbers of precursor metal bodies that join together in a three-dimensional porous matrix. Each of the precursor metal bodies can join to 1, 2, 3, 4, 5, or more other metal precursor metal bodies to form the three-dimensional porous matrix.

The amount of material used to form the outer portion can be expressed in terms of relative weight or thickness. For example, in some embodiments, the outer portion comprises about 10 weight percent (wt %) of the metal body precursor. The outer portion typically comprises between about 0.05 wt % and about 30 wt % of the metal body precursor. In other embodiments, the outer portion has an average thickness in the ranges of from about 0.001 μm to about 0.5 μm. In some embodiments, the outer portion has an average thickness in the range of from about 0.01 μm to about 0.05 μm. An exemplary useful precursor metal body having a copper inner portion and silver outer portion is available as “SILVER COATED COPPER POWDER #107” from Ferro Corp. (Plainfield, N.J.). Other useful precursor metal bodies include, for example, aluminum particles coated with magnesium. The precursor metal bodies can be formed using any methods known to those in the art, including, for example, physical vapor deposition (see, e.g., U.S. Pat. Publ. 2005/0095189 (Brey et al.)), plasma deposition, electroless plating, electrolytic plating, or immersion plating.

A plurality of interstitial elements can be disposed between and connecting at least two of the plurality of precursor metal bodies to one another. The interstitial elements can include the alloy of the outer portion. The interstitial elements can be formed by subjecting the precursor metal bodies to an elevated temperature such that the metals of the inner and outer portions of the precursor metal bodies form an alloy that bonds the bodies together. This process is known as isothermal re-solidification. In some embodiments, a eutectic can be formed that has a lower melting point than the individual metals that form the alloy. The formation of the eutectic can be temporary as diffusion during the isothermal re-solidification process can cause continuous change in the composition of the interfaces of the various metals. In some embodiments, the isothermal re-solidification process occurs in a reducing or vacuum furnace, such as, for example, a VCT model vacuum furnace available from Hayes of Cranston, R.I.

Thermal transfer porous metallic coatings and methods of making and using the same have been disclosed, for example, in U.S. Pat. Publ. No. 2007/0102070 (Tuma et al.). These coatings can be useful embodiments as precursors to the provided articles and methods before they are heated to form an inner alloy and an outer alloy. Structured thermal transfer articles that can be used to make embodiments of the provided articles and methods have been disclosed, for example, in U.S. Pat. No. 7,360,581 (Tuma et al.).

The provided porous structured thermal transfer articles include a plurality of metallic particles at least partially embedded in the alloy of the outer portion. These particles can comprise copper or other metals and can be of many sizes and shapes. In some embodiments, the particles can be derived from metallic foam, flakes or fibers or bundles or braids of metallic fibers, to name a few. The particles can be present in a loading of between about 0.002 g/cm² and about 0.10 g/cm², between about 0.02 g/cm² and about 0.08 g/cm², or even between about 0.02 g/cm² and about 0.06 g/cm² on the surface of the article. The particles can have an average dimension of from about 0.5 mm to about 40 mm long, from about 1 mm to about 20 mm long, or even from about 1 mm to about 10 mm long. The particles can have an average dimension of from about 10 μm to about 200 μm in diameter, from about 15 μm to about 100 μm in diameter, from about 50 μm to about 100 μm in diameter or, from about 25 μm to about 150 μm in diameter. The particles can be substantially spherical, substantially spheroid, or in the general shape of a regular or irregular solid polyhedrons. The particles can also take the shape of other randomly shaped bodies, including for example, fibers, flakes, chips, plates, cylinders, and needle-shaped bodies. The particles can have an aspect ratio of about 1, about 2, about 5, about 10, about 20, about 50, about 100, about 200, about 300, or even higher.

In some embodiments, the porous structured thermal transfer articles of the present disclosure have a metal body density in the range of about 10⁶ to 10¹¹ precursor metal bodies per cubic centimeter. In some embodiments, the porous structured thermal transfer articles of the present disclosure have a metal body density in the range of about 10⁷ to 10⁹ precursor metal bodies per cubic centimeter. The effective porosity of the structured thermal transfer article of the present disclosure can be typically in the range of 10 to 60 percent. In some embodiments, the effective porosity of the structured thermal transfer article can be at least 20 percent. In yet further embodiments, the effective porosity of the structured thermal transfer article can be at least 30 percent.

In another aspect, provided is a porous structured thermal transfer article that includes a plurality of composite bodies that include an inner portion comprising diamond and a first metal selected from aluminum, copper, silver, and alloys thereof, and an outer portion comprising an alloy comprising the first metal and a second metal selected from copper, silver, silicon, and magnesium, wherein the first metal and the second metal are different; a plurality of interstitial elements disposed between and connecting the plurality of precursor metal bodies to one another, the interstitial elements comprising the alloy of the outer portion; and a plurality of metallic particles at least partially embedded in the alloy of the outer portion. Although not wishing to be bound by any theory, the thermal conductivity of the encapsulated diamonds is believed to enhance the performance of the structured thermal transfer article. In some embodiments, diamonds (coated or uncoated) can be combined with the plurality of precursor metal bodies (with or without internal diamonds) to form a structured thermal transfer article having a mixture of precursor metal bodies and diamonds held together with interstitial elements. Other materials can also be encapsulated or combined with the precursor metal bodies, including, for example, polycrystalline diamonds, synthetic diamond, polycrystalline diamond compacts (PDC), pure diamond, and combinations thereof. The intermediate coating that coats the diamond can comprise any known carbide former, including, for example, chromium, cobalt, manganese, molybdenum, nickel, silicon, tantalum, titanium, tungsten, vanadium, zirconium, and alloys thereof. The intermediate coating can be applied to the diamond using any techniques known in the art, including, for example, physical vapor deposition, chemical vapor deposition, molten salt deposition (see, e.g., EP 0 786 506 A1 (Karas et al.)), electrolysis in molten salt, and mechanical plating. In some embodiments, the intermediate coating that coats the diamond comprises multiple layers.

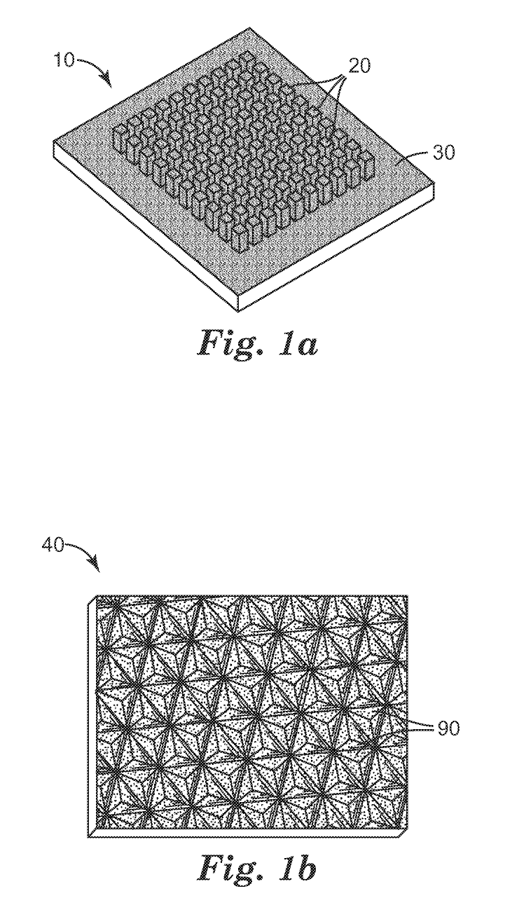

Turning to the figures, FIGS. 1a and 1b are perspective views substrates that have a thermal transfer coating and can be useful for making embodiments of the provided articles. As shown in FIG. 1a, the thermal transfer coating can be applied to substrate 10 having a three-dimensional surface. The three-dimensional surface can include an array of projections, such as fins 20, or other features that increase the surface area of the boiler. FIG. 1b is a perspective view of a substrate 40 that can be used to make embodiments of the provided articles. As shown in FIG. 1b, substrate 40 comprises a plurality of shaped thermal transfer composites 90. The thermal transfer composites comprise a plurality of precursor metal bodies. These substrates have not been heated or undergone isothermal re-solidification in order to be useful for making embodiments of provided porous structured thermal transfer articles.

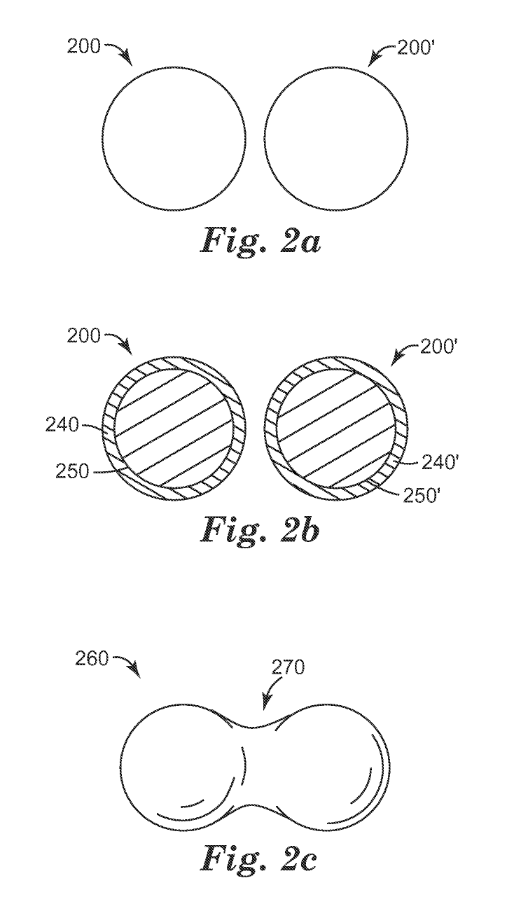

FIGS. 2a-2c illustrate a sequence by which substrates useful for forming provided porous structured thermal transfer articles can be formed. The figures are a simplified representation showing two exemplary precursor metal bodies being joined. The substrates useful for making embodiments of provided porous structured thermal transfer articles typically are formed from large numbers of precursor metal bodies that join together in a three-dimensional porous matrix.

FIG. 2a is a side view of two exemplary precursor metal bodies used to make substrates that can be useful for the production of provided porous structured thermal transfer articles. In embodiments such as shown in FIG. 2a, the precursor metal bodies 200 and 200′ can be about the same size. In other embodiments, the precursor metal bodies can vary in size. The precursor metal bodies can be substantially spherical as shown in FIG. 2a.

FIG. 2b is a cross-sectional view of the two exemplary precursor metal bodies 200 and 200′ shown in FIG. 2a. As shown in FIG. 2b, each precursor metal body comprises inner portions 250 and 250′, and outer portions 240 and 240′. In some embodiments, inner portions 250 and 250′ comprise a metal selected from aluminum, copper, silver, and alloys thereof. In some embodiments, outer portions 240 and 240′ comprise a metal selected from copper, silver, magnesium, and alloys thereof. In yet further embodiments, the inner portions have a metal having a melting temperature Tₘₚ₁, the outer portions have a metal having a melting temperature Tₘₚ₂, and upon heating to a temperature less than Tₘₚ₁ or Tₘₚ₂, an alloy is formed comprising the metals of the inner and outer portions. In some embodiments, the metals in the inner and outer portion of the precursor metal bodies are selected based upon their thermal conductivity and/or their alloy forming characteristics.

FIG. 2c is a side view of the two exemplary precursor metal bodies 200 and 200′ shown in FIGS. 2a and 2b joined together to form structure 260. As shown in FIG. 2c, an interstitial element 270 is formed to attach the two bodies together using methods of the present disclosure.

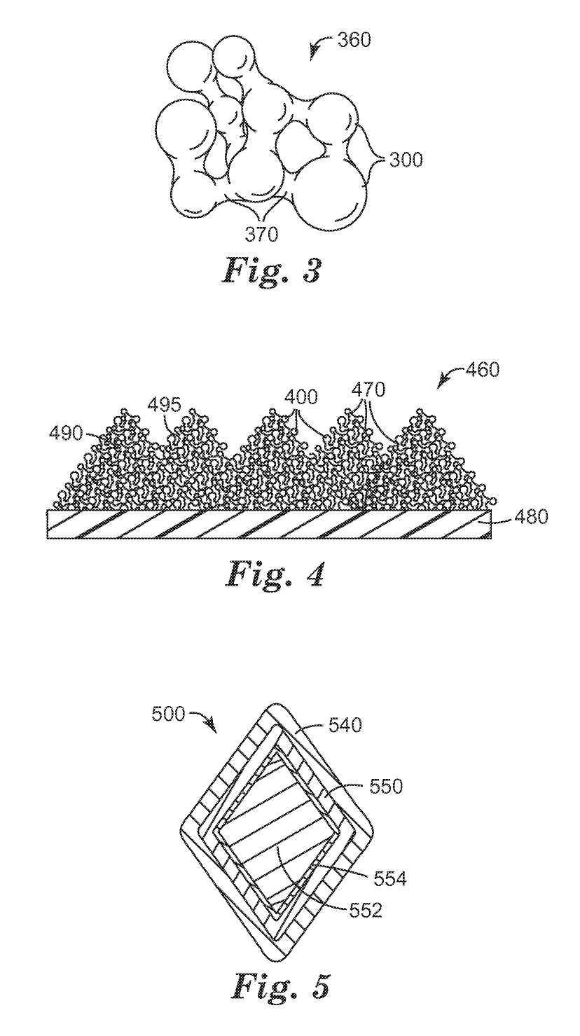

FIG. 3 is a perspective view of a portion of a thermal transfer composite (substrate removed) after undergoing isothermal re-solidification. As shown in FIG. 3, the portion of the thermal transfer composite 360 comprises a plurality of metal bodies 300 connected to one another with interstitial elements 370 to form a three-dimensional porous matrix.

FIG. 4 is an exemplary cross-sectional side view of a portion 460 of an embodiment of a substrate that can be used to make embodiments of provided articles. As shown in FIG. 4, the portion 460 of an embodiment of a substrate comprises a plurality of precisely shaped thermal transfer composites 490 and 495, each having a pyramid shape, affixed to an optional substrate 480. The cross-sectional view of composite 490 partially blocks out the view of the lower portion of composite 495, which is located behind composite 490. It should be understood, however, that composites 490 and 495 have similar shapes and dimensions. The composites can comprise a plurality of precursor metal bodies 400 connected to one another with interstitial elements 470 after undergoing isothermal re-solidification. Metallic particles can be added to the composites before isothermal re-solidification to produce provided articles.

As discussed above, the portion 460 depicts an exemplary embodiment of a substrate that can be used to make the provided articles which has precisely shaped thermal transfer composites 490 and 495. In other embodiments, the thermal transfer composites are not precisely shaped, but are simply three-dimensionally shaped. The three dimensional shapes can be random in shape and/or size, or can be uniform in shape and/or size. In some embodiments, the thermal transfer composites comprise random shapes and sizes formed by dropping varying sized “droplets” of the precursor metal bodies in a binder onto a surface without the use of a mold. The surface can become an integral part of the structured thermal transfer article (i.e., the substrate), or the structured thermal article can be removed from the surface after formation

FIG. 5 is a cross-sectional view of an exemplary precursor metal body comprising a coated diamond in the inner portion. As shown in FIG. 5, the inner portion of the precursor metal body comprises a diamond 552, an intermediate coating 554, and the first metal 550. The outer portion 540 comprises the second metal. The intermediate coating that coats the diamond can comprise any known carbide former, including, for example, chromium, cobalt, manganese, molybdenum, nickel, silicon, tantalum, titanium, tungsten, vanadium, zirconium, and alloys thereof. The intermediate coating can be applied to the diamond using any techniques known in the art, including, for example, physical vapor deposition, chemical vapor deposition, molten salt deposition (see, e.g., EP 0 786 506 A1 (Karas et al.)), electrolysis in molten salt, and mechanical plating. In some embodiments, the intermediate coating that coats the diamond comprises multiple layers.

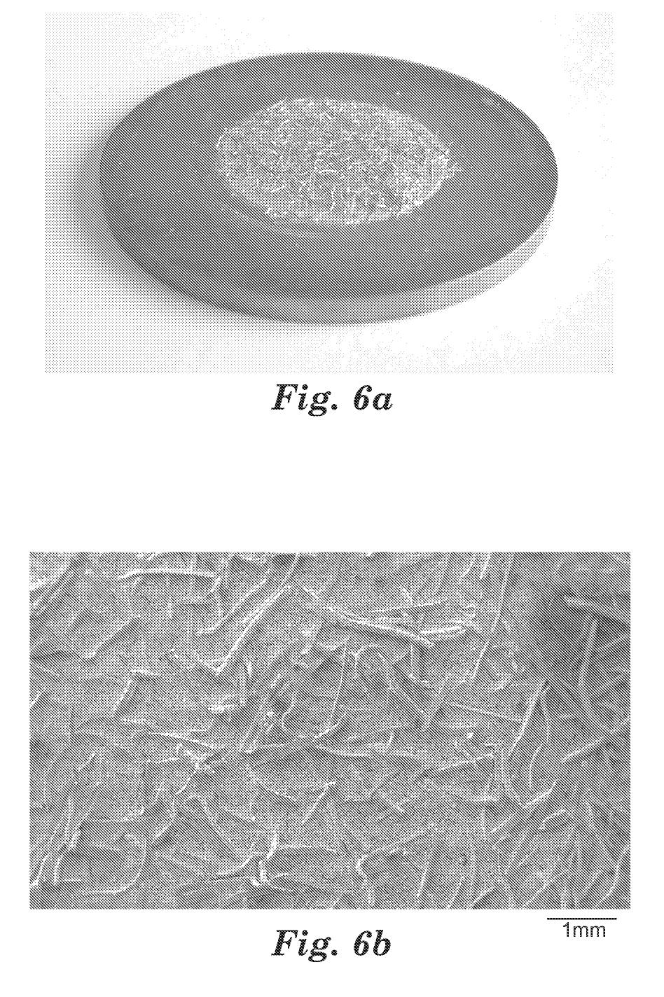

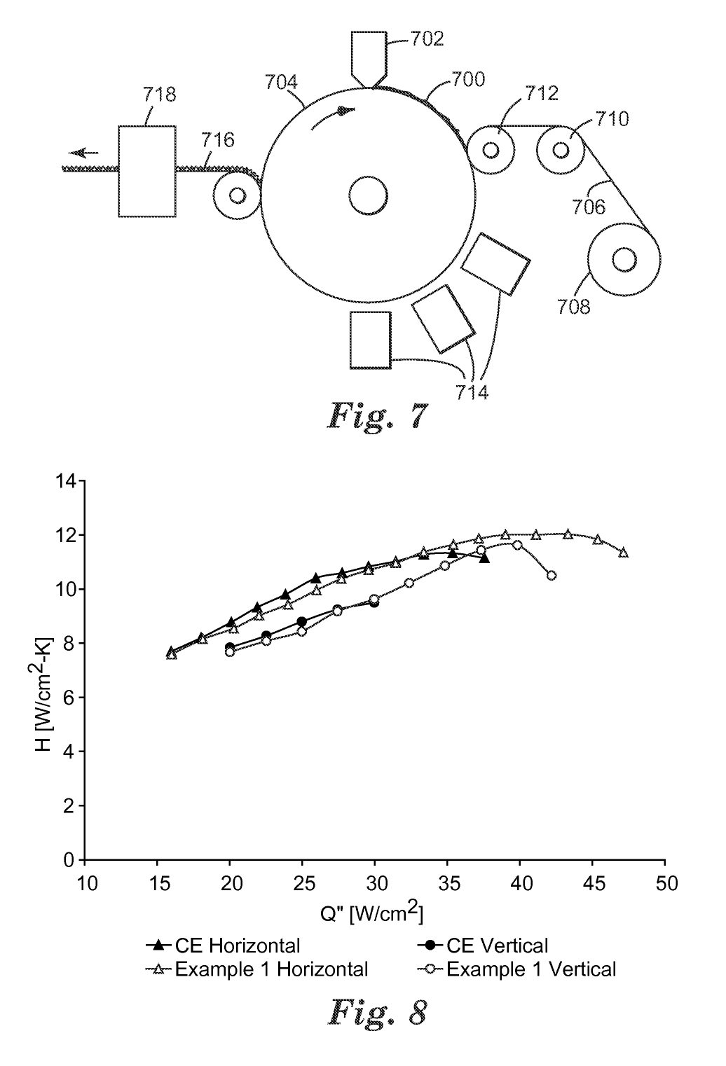

FIGS. 6a and 6b are photomicrographs of an embodiment of the provided apparatus at different magnifications. FIG. 6a shows a porous structured thermal transfer article in the form of a plate that has a porous thermal transfer composite that has been embedded with fine copper particles. FIG. 6b is a magnification of the article and more clearly shows metallic copper particles that are at least partially embedded in the alloy of the outer portion of the article. These particles are about 2 mm long and 75 μm in diameter and have an aspect ratio of about 26.

Also provided is a method of forming a structured thermal transfer article that includes providing a thermal transfer coating that includes a binder and a plurality of precursor metal bodies, the precursor metal bodies comprising an inner portion comprising a first metal having a melting temperature Tₘₚ₁, and an outer portion comprising a second metal having a melting temperature Tₘₚ₂, applying a plurality of metallic particles to the coating, and heating the composition to a temperature less than Tₘₚ₁ and Tₘₚ₂ to form an alloy comprising the first metal and the second metal that bonds the plurality of precursor metal bodies to one another, wherein the bond forms a porous matrix, and wherein the plurality of metallic particles is at least partially embedded in at least a portion of the matrix.

FIG. 7 is a schematic view of an exemplary apparatus for forming a structured thermal transfer article that includes providing a thermal transfer coating that includes a binder and a plurality of precursor metal bodies. As shown in FIG. 7, slurry 700 comprising the precursor metal bodies and a binder flows out of feeding trough 702 by pressure or gravity and onto production tool 704, filling in cavities (not shown) therein. If slurry 700 does not fully fill the cavities, the resulting structured thermal transfer article will have voids or small imperfections on the surface of the thermal transfer composites and/or in the interior of the thermal transfer composites. Other ways of introducing the slurry to the production tool include die coating and vacuum drop die coating. The viscosity of the slurry is preferably closely controlled for several reasons. For example, if the viscosity is too high, it will be difficult to apply the slurry to the production tool.

Production tool 704 can be a belt, a sheet, a coating roll, a sleeve mounted on a coating roll, or a die. In some preferred embodiments, production tool 704 is a coating roll. Typically, a coating roll has a diameter between 25 and 45 centimeters and is constructed of a rigid material, such as metal. Production tool 704, once mounted onto a coating machine, can be powered by a power-driven motor.

Production tool 704 has a predetermined array of at least one specified shape on the surface thereof, which is the inverse of the predetermined array and specified shapes of the thermal transfer composites. Production tools for the process can be prepared from metal, although plastic tools can also be used. Production tools can be made of metal and can be fabricated by engraving, hobbing, assembling as a bundle a plurality of metal parts machined in the desired configuration, or other mechanical means, or by electroforming. These techniques are further described in the Encyclopedia of Polymer Science and Technology, Vol. 8, John Wiley & Sons, Inc. (1968), p. 651-665, and U.S. Pat. No. 3,689,346 (Rowland). In some instances, a plastic production tool can be replicated from an original tool. The advantage of plastic tools as compared with metal tools is cost. A thermoplastic resin, such as polypropylene, can be embossed onto the metal tool at its melting temperature and then quenched to give a thermoplastic replica of the metal tool. This plastic replica can then be utilized as the production tool.

Substrate 706 departs from an unwind station 708, then passes over an idler roll 710 and nip roll 712 to gain the appropriate tension. Nip roll 712 also forces backing 706 against slurry 700, thereby causing the slurry to wet out backing 706 to form an intermediate article. The slurry is dried using energy source 714 before the intermediate article departs from production tool 704. After drying, the specified shapes of the thermal transfer composites do not change substantially after the structured thermal transfer article departs from production tool 704. Thus, the structured thermal transfer article is an inverse replica of production tool 704. The structured thermal transfer article 716 departs from production tool 604, is treated with metallic particles, and passes through the isothermal re-solidification oven 718.

The provided porous structured thermal transfer article can also be made according to the following method. First, a slurry containing a mixture of precursor metal bodies and a binder can be introduced to a backing having a front side and a back side. The slurry can wet the front side of the backing to form an intermediate article. Second, the intermediate article can be introduced to a production tool. Third, the slurry is at least partially dried before the intermediate article departs from the outer surface of the production tool. Fourth, metallic particles are applied to the intermediate article. Finally, the intermediate article is heated to a temperature at which isothermal re-solidification occurs and the structured thermal transfer article is formed. The steps can be conducted in a continuous manner, thereby providing an efficient method for preparing a structured thermal transfer article. The second method is similar to the first method, except that in the second method the slurry is initially applied to the backing rather than to the production tool.

In some preferred embodiments, the structures that are useful for making the provided porous structured thermal transfer articles comprise a plurality of thermal transfer composites arranged in the form of a pre-determined pattern. At least some of the composites may be precisely shaped abrasive composites. In some embodiments, the composites have substantially the same height. The useful structures typically include at least about 1,200 composites per square centimeter of surface area. The useful structures typically have an average thickness in the range of from about 20 to about 1,000 μm. In some embodiments, the useful structures have an average thickness in the range of from about 50 to about 500 μm.

The thermal transfer composites can have a variety of shapes, including, for example, cubic, cylindrical, prismatic, rectangular, pyramidal, truncated pyramidal, conical, truncated conical, cross, post-like with a flat top surface, hemispherical, and combinations thereof. The thermal transfer composites can vary also vary in size. The thermal transfer composites typically have an average height in the range of from about 20 to about 1,000 μm. In some embodiments, the thermal transfer composites have an average height in the range of from about 50 to about 500 μm. In some embodiments, a variety of shapes and/or sizes are used to form the thermal transfer composites.

Metallic particles can be added atop and among the previously applied composites manually or mechanically as needed to achieve the desired density and orientation. For example, particles can be weighed to achieve the desired quantity and then applied by hand in a random fashion atop the previously applied composites. Alternatively, particles can be inserted into the previously applied composites by mechanical means at prescribed locations. The provided structured thermal transfer articles can be used in cooling systems, such as, for example, passive cooling systems such as thermosyphons. The structured thermal transfer article can be applied directly to the heat-generating device or a heat-dissipating device in thermal communication with the heat-generating device. The provided structured thermal transfer articles can have a heat transfer coefficient of at least 3 watts per square centimeter per degree Celsius (W/cm²/° C.) at a heat flux of at least 10 W/cm². In some embodiments, the provided structured thermal transfer articles have a heat transfer coefficient of at least 6 W/cm²/° C. at a heat flux of at least 10 W/cm². Fluids, such as hydrofluoroethers that are clear, colorless, have excellent toxicological properties and are environmentally friendly can be used to facilitate heat transfer. NOVEC Engineered Fluids, such as HFE-7000, HFE-7100, HFE-7200 and HFE-711PA, available from 3M Company, St. Paul, Minn. are fluids that can be useful in systems that have the provided structured thermal transfer articles. More common but less environmentally friendly fluids such as hydrofluroocarbon refrigerants, for example, HFC-134a, or HFC-245fa can also be used. Hydrofluoroolefin refrigerants such HFO-1234yf as can also be used. It is also contemplated that hydrocarbon refrigerants such as propane or butane can be useful as heat transfer fluids.

Advantages and other embodiments of the structured thermal transfer article of the present disclosure are further illustrated by the following examples, but the particular materials and amounts thereof recited in these examples, as well as other conditions and details, should not be construed to unduly limit the structured thermal transfer article of the present disclosure. For example, the metals used to form the precursor metal bodies can vary. All parts and percentages are by weight unless otherwise indicated.

### EXAMPLE

### Materials

Precursor metal bodies comprise sub 325 mesh copper particles sputter coated with silver using a process described in U.S. Pat. Publ. 2005/0095189 A1. The resultant particles contained 0.4-0.9 wt % Ag. The source for these copper particles was Chem Copp copper powder 1700 FPM, American Chemet Corporation, Deerfield, Il.

Structured thermal transfer articles were prepared and boiling experiments were conducted using the methods described below.

### Preparation of Thermal Transfer Articles

### Comparative Example

Substrates for the thermal transfer articles were made of 5.0 cm diameter machined copper disks 0.3 cm thick. One surface of these disks contained a 1 mm thermocouple groove machined to a depth of about 2 mm and terminating at the disk centerline. This surface was also lapped flat and polished. Precursor metal bodies were mixed with 13 wt % diffusion pump oil (Dow 704 made by Dow Chemical, Midland Mich., USA). This slurry was applied to the central 25 mm diameter on the bare side of the copper disk using conventional hand screen printing techniques and a polymer mesh screen (45-180 W IM E11F 0.5 30d STD made by Sefar of Thal Switzerland). The resultant coating contained 0.052 g of precursor metal bodies per square centimeter.

### Example 1

Thermal transfer coatings comprising precursor metal bodies were prepared as described above. Fine copper particles with a diameter of 75 μm and length of 2 mm were prepared by cutting up a piece of copper wool (#706 made by Palmer Engineered Products, Springfield Ohio). These copper fibers were applied by hand, at a density of about 0.025 g/cm², atop the circular region of the thermal transfer coating comprising the precursor metal bodies

Both the Comparative Example and Example 1 were put into a vacuum furnace. The pressure was reduced to below 0.001 mm of mercury while the furnace temperature was raised at about 14° C./min to 300° C. and held at 300° C. for 15 min to remove the oil. The furnace was then heated to 850° C. at about 14° C./min, held at that temperature for one hour and then allowed to cool to near room temperature before the vacuum was broken and the part removed.

### Pool Boiling

An apparatus was built to permit rapid testing of many structured thermal transfer articles. The apparatus comprised a top hat shaped copper pedestal with a 40 mm diameter base 10 mm high that reduced to 25 mm diameter. The overall height was 20 mm. The

25 mm diameter surface was lapped flat and polished. A Mica heater (Minco HM6807R3.9L12T1) was bolted to the 40 mm diameter surface.

The apparatus further comprised an assembly frame that held the previously described copper pedestal heater assembly atop an insulated surface with the polished surface facing upward. The frame also held a stainless steel sheathed thermocouple parallel to and about 2 mm above the polished surface and terminating at its centerline. The thermal transfer article was set atop the polished surface with diamond based thermal interface grease (3M developmental TIM AHS-1055M) in the interface. It was applied in such a way that the thermocouple inserted into the thermocouple groove in the thermal transfer article with axial stress to ensure good thermal contact at the tip of the thermocouple. This provided the sink temperature, Tₛᵢₙₖ. A cam lock mechanism forced this assembly against a 25 mm ID gasketed glass tube that sealed to the copper disk and applied the needed pressure to achieve a good thermal interface. The glass tube was connected to an air cooled condenser that was open at the top to ambient pressure.

An apparatus similar to that described above was used to test structured thermal transfer articles while they were oriented in a vertical plane. This apparatus used an acrylic housing in place of the glass tube described previously. This created approximately a 15 cm³ cylindrical chamber adjacent to the boiling surface from which a passage moved radially upward to an air cooled condenser.

About 15 mL of 3M NOVEC ENGINEERED FLUID HFE-7000 (available from 3M Company, St. Paul, Minn.) was then added though the top of the aforementioned assembly to form a pool atop the thermal transfer article. A thermocouple inserted in the glass tube above the liquid and below the condenser was used to measure the fluid saturation temperature, Tₛₐₜ.

An automated data acquisition system applied DC voltage, V, to the heater. The voltage was initially set to achieve approximately Q=80 W of power. The power was then progressed in 10 W increments until Tₛᵢₙₖ exceeded a preset limit indicating that the critical or dryout heat flux had been reached. Before progressing to the next increment, the heater voltage, V, and current, I, were recorded. These were then used to calculate the heat flux to the heater, Q″, based upon the area of the coated surface of the test disks, πD²/4:

$${Q}^{″} = \frac{4 Q}{π {D}^{2}}$$

The heat transfer coefficient, H, is then calculated as

$$H = \frac{{Q}^{″}}{{T}_{w} - {T}_{sat}}$$

The heat transfer coefficients versus heat flux for the Comparative Example and Example 1 were measured with 3M NOVEC HFE-7000 as the working fluid and are shown in FIG. 8 and described above.

The Comparative Example surface was able to sustain a heat flux of about 37 W/cm² when oriented in a horizontal plane (CE Horizontal in FIG. 8). This same surface could sustain only 30 W/cm² when oriented in a vertical plane (CE Vertical in FIG. 8). The Example 1 surface was able to sustain a heat flux of about 47 W/cm² when oriented in a horizontal plane (Example 1 Horizontal in FIG. 8). This same surface could sustain 42 W/cm² when oriented in a vertical plane (Example 1 Vertical in FIG. 8).

It is to be understood that even in the numerous characteristics and advantages of the structured thermal transfer articles of the present disclosure set forth in the above description and examples, together with details of the structure and function of the structured thermal transfer articles, the disclosure is illustrative only. Changes can be made to detail, especially in matters of shape and size of the precursor metal bodies and methods of use within the principles of the present disclosure to the full extent indicated by the meaning of the terms in which the appended claims are expressed and the equivalents of those structures and methods. All references cited in this application are herein incorporated by reference in their entirety.

What is claimed is:

1. A porous structured thermal transfer article comprising:
a plurality of precursor metal bodies comprising an inner portion comprising a first metal selected from aluminum, copper, silver, and alloys thereof, and an outer portion comprising an alloy that includes the first metal and a second metal selected from copper, silver, silicon, and magnesium, wherein the first metal and the second metal are different;
a plurality of interstitial elements disposed between and connecting at least two of the plurality of precursor metal bodies to one another, the interstitial elements comprising the alloy of the outer portion; and
a plurality of metallic particles at least partially embedded in the alloy of the outer portion.

2. The article according to claim 1 wherein the first metal comprises copper or aluminum.

3. The article according to claim 1 wherein the interstitial elements comprise an alloy of silver and copper or an alloy of aluminum and magnesium.

4. The article according to claim 1 wherein the inner portion further comprises diamond.

5. The article according to claim 4 wherein the diamond comprises an intermediate coating comprising a carbide former selected from the group consisting of chromium, cobalt, manganese, molybdenum, nickel, silicon, tantalum, titanium, tungsten, vanadium, zirconium, and alloys thereof, wherein the first metal is affixed to the intermediate coating.

6. The article according to claim 1 wherein the precursor metal bodies comprise an average diameter in the range of 5 to 50 micrometers.

7. The article according to claim 1 wherein the particles comprise copper.

8. The article according to claim 1 wherein the particles are present in a loading of between about 0.02 and 0.06 g/cm² on the surface of the article.

9. The article according to claim 1 wherein the particles have average dimensions of from about 1 mm to about 10 mm long and from about 25 μm to about 100 μm in diameter.

10. The article according to claim 1 wherein the particles have an aspect ratio greater than 20.

11. The article according to claim 1 wherein the particles have an aspect ratio greater than 100.

12. The article according to claim 1 wherein the structured thermal transfer article has an effective porosity of at least 20 percent.

13. A cooling system comprising the structured thermal transfer article according to claim 1.

14. The cooling system according to claim 13 comprising a thermosyphon.

15. An electronic device comprising a cooling system comprising the structured thermal transfer article according to claim 1.

16. The electronic device according to claim 15 wherein the device is a microprocessor, insulated gate bipolar transistor, or a combination thereof.

17. The electronic device according to claim 15 wherein the structured thermal transfer article has an orientation that is substantially vertical to the horizontal plane.

18. A method of forming a structured thermal transfer article comprising:
providing a thermal transfer coating that includes a binder and a plurality of precursor metal bodies, the precursor metal bodies comprising:
an inner portion comprising a first metal having a melting temperature Tₘₚ₁, and
an outer portion comprising a second metal having a melting temperature Tₘₚ₂;
applying a plurality of metallic particles to the coating; and
heating the composition to a temperature less than Tₘₚ₁ and Tₘₚ₂ to form an alloy comprising the first metal and the second metal that bonds the plurality of precursor metal bodies to one another, wherein the bond forms a porous matrix, and wherein the plurality of metallic particles is at least partially embedded in at least a portion of the matrix.

19. The method according to claim 18 wherein the metallic particles comprise copper.

20. The method according to claim 18 further comprising a production tool.
